(19) United States
(12) Patent Application Publication
(10) Pub. No.: US 2008/0053129 A1
(43) Pub. Date: Mar. 6, 2008

(54) Vehicle Rooftop Engine Cooling System and Method

(75) Inventors: David Follette, San Diego, CA (US); Kevin Stone, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 11/932,914

(22) Filed: Oct. 31, 2007

Related U.S. Application Data
(63) Continuation-in-part of application No. 11/169,184, filed on Jun. 28, 2005.
Application No. 11/169,184 is a continuation-in-part of application No. 10/339,735, filed on Jan. 8, 2003, now Pat. No. 6,910,529.

(51) Int. Cl. B60H 1/32

(52) U.S. Cl. 62/244

(57) ABSTRACT

An vehicle rooftop cooling system includes a radiator located outside of the engine compartment of a vehicle, the radiator having a liquid coolant inside the radiator; a fan coupled to the radiator and configured to extract hot air from the radiator; a first sensor proximate to the radiator configured to measure coolant temperature of the coolant in the radiator; and a controller communicably coupled to the first sensor, the controller configured to receive inputs from the first sensor, to make determinations based on the received inputs, and to communicate control signals across a controller area network (CAN) in response to said determinations, wherein the controller is further configured to communicate a first control signal to cool the liquid coolant upon determining that the first sensor has measured temperature above a threshold.

### CROSS-REFERENCE TO RELATED APPLICATIONS

This application is a continuation-in-part application and claims the benefit of U.S. application Ser. No. 11/169,184, filed on Jun. 28, 2005, which is a continuation-in-part application and claims the benefit of U.S. application Ser. No. 10/339,735, filed on Jan. 8, 2003, which issued as U.S. Pat. No. 6,910,529 on Jun. 28, 2005. The above applications are hereby incorporated by reference as though set forth in full.

### FIELD OF THE INVENTION

The field of the invention relates to systems and methods for cooling motor vehicle engines and other vehicular components of transit buses (e.g., gasoline, diesel, hydrogen, electric drive transit buses).

### BACKGROUND OF THE INVENTION

Some type of radiator or heat exchanger is normally required to remove heat from an internal combustion engine. For most applications, the power required to turn the fan that moves air through the radiator has been obtained through some mechanical, hydraulic, or belt-driven connection to the engine crankshaft.

A conventional radiator includes an intake tank, a core made up of a plurality of finned tubes, and an exit tank connected by hoses. The radiator may be used to cool the means of propulsion (e.g., gas engine, diesel engine, hydrogen fuel cell engine, electric motor) in the motor vehicle. The radiator may be filled with a coolant to radiate superfluous heat from the engine into the air by means of conduction and convection. Fans, which may be powered by the vehicle engine or electrically powered, propel ambient air near the surface of the road through the radiator core to accelerate the cooling process. The radiator is typically placed in a vertical orientation in close proximity to the vehicle engine in a tight, confined engine compartment. The fan draws the air through the radiator core area and directs it around the confined engine compartment. The ambient air passing through the radiator is heated and passes over the engine, tightly enclosed within the engine compartment. The air then is forced downward, under the vehicle. The location of the radiator often makes it difficult to perform maintenance on the engine. In some cases, the radiator shroud or the complete radiator must be removed to perform certain tasks.

Large vehicles such as transit buses, motor homes, and delivery vans have limited frontal access to the engine compartment that is often partially or completely blocked by the radiator of the vehicle. This can make maintenance on the engine or other engine compartment components very difficult. Standard bus radiator installations are close to the street level, typically on the street side of the bus. This low mounting location increases the dirt and debris collected by the radiator, and, hence, increases the number of times the radiator needs to be cleaned and checked, and decreases the cleaning intervals. Radiator cleaning requirements stipulate that the radiator be cleaned in the opposite direction of the airflow. Therefore, most radiators need to be cleaned from the inside of the engine compartment. This may require partial disassembly of the radiator shroud to effectively clean the radiator, increasing the time and complexity of the radiator cleaning process.

### SUMMARY OF THE INVENTION

Accordingly, an aspect of the invention relates to a new and unique vehicle rooftop engine cooling system that improves the efficiency of present engine cooling systems used on buses. The engine cooling system includes one or more radiator units that are preferably horizontally oriented on the rooftop of a bus. Interconnected tubing connects the engine in the engine compartment to the one or more radiator units on the rooftop of a vehicle.

Horizontally orienting the one or more radiator units on the rooftop of a vehicle reduces the power load of the radiator fans on the internal combustion engine and/or battery. The horizontal rooftop engine cooling system may include electrically driven, thermostatically controlled fans to assist in cooling the rooftop engine cooling system. The large surface area of the roof top of the bus significantly reduces the fan power requirement by more than a factor of ten compared to a standard radiator in an engine compartment. The larger surface area of the roof top reduces the required airspeed through the radiator units and the required air pressure drop across the radiator units, thus, increasing the cooling system efficiency of the radiator units. For example, standard bus radiators/intercoolers consume up to 50 HP of engine power to drive the radiator cooling fan alone. The electrically driven radiator fans used with the horizontal rooftop engine cooling system consume less than 3 HP of engine power for equivalent cooling.

The horizontal rooftop engine cooling system also allows for natural convection air current to rise through the radiator units in an unconfined area. With the radiator unconfined on the rooftop of the vehicle, and with less demanding size limitations, the heat may be dissipated in a natural upward direction, minimizing the use of the electrically driven, thermostatically controlled fans. Consequently, the load of the electrically driven, thermostatically controlled fans is far less than that of fans of a standard radiator located in the engine compartment of a vehicle or even hydraulically powered fans mounted vertically on the rooftop.

A further benefit of locating the cooling system horizontally on the rooftop of the vehicle is that some of the cleanest and coolest air is available at the altitude of the rooftop. The cleanest air is available at the altitude of the rooftop cleanest because there is no road grime at this altitude. The coolest air is available at the altitude of the rooftop cleanest because there is no road heat. This cleaner, cooler air at the altitude of the rooftop reduces the number of times the radiator needs to be serviced and increases the duration between radiator cleanings. The large surface area of the rooftop of the transit bus allows for a larger radiator area, which reduces fan power requirements/noise.

Because radiator cleaning requirements stipulate that the radiator be cleaned in the opposite direction of the airflow, the cooling system can be cleaned by simply spraying water through the fan orifices and shroud openings from outside of the cooling system. This type of cleaning would occur each time the bus passes through a normal bus wash cycle without any component disassembly. This is much simpler and less time-consuming than cleaning a radiator from the inside of the engine compartment, which may require partial disassembly of the radiator shroud to effectively clean the radiator.

A further aspect of the invention involves a vehicle cooling system. The vehicle cooling system includes a radiator located outside of the engine compartment of a vehicle, the radiator having a liquid coolant inside the radiator; a fan coupled to the radiator and configured to extract hot air from the radiator; a first sensor proximate to the radiator configured to measure coolant temperature of the coolant in the radiator; and a controller communicably coupled to the first sensor, the controller configured to receive inputs from the first sensor, to make determinations based on the received inputs, and to communicate control signals across a controller area network (CAN) in response to said determinations, wherein the controller is further configured to communicate a first control signal to cool the liquid coolant upon determining that the first sensor has measured temperature above a threshold.

A further aspect of the invention involves a method of controlling a vehicle cooling system including a radiator located outside of the engine compartment of a vehicle, the radiator having a liquid coolant inside the radiator; a fan coupled to the radiator and configured to extract hot air from the radiator; a first sensor proximate to the radiator configured to measure temperature of the coolant in the radiator; a controller communicably coupled to the first sensor, the controller configured to receive inputs from the first sensor, to make determinations based on the received inputs, and to communicate control signals across a controller area network (CAN) in response to said determinations, wherein the controller is further configured to communicate a first control signal to cool the liquid coolant upon determining that the first sensor has measured temperature above a threshold. The method includes the steps of measuring coolant temperature of the coolant in the radiator with the first sensor; receiving temperature sensor input from the first sensor at the controller; and communicating via the CAN the first control signal to cool the liquid coolant in the radiator upon determining that the first sensor has measured temperature above a threshold.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a perspective view of an embodiment of a horizontal rooftop engine cooling system with two radiator units, fan mounting shrouds, and an optional overflow tank all mounted perpendicular to the direction of vehicle travel. Alternatively, the cooling system may be mounted parallel to the direction of vehicle travel.

FIG. 2 is a top plan view of the horizontal rooftop engine cooling system illustrated in FIG. 1 with the optional overflow tank and portions of a fan mounting shroud broken away to reveal a radiator intake tank, a radiator core, and an exit tank.

FIG. 3 is a cross-sectional view of the horizontal rooftop engine cooling system of FIG. 1 taken along lines 3-3 of FIG. 1 and shows a radiator of one of the radiator units in a horizontal position.

FIG. 4 is block diagram of an embodiment of a continuously variable power drive and speed control system for the rooftop fans of the rooftop engine cooling system.

FIG. 5 is a top plan view of another embodiment of a rooftop engine cooling system where the rooftop engine cooling system includes a footprint area that occupies substantially all of the area of the rooftop of the bus.

FIG. 6 is a block diagram of an embodiment of a rooftop cooling system that cools one or more of a generator, motor(s), inverter drive controller(s), charge air cooler, bus electric drive element(s), and other electrical component(s) of the bus requiring cooling.

FIG. 7 is block diagram of another embodiment of a control system for the rooftop fans of the rooftop engine cooling system.

FIG. 8 is a block diagram illustrating an example computer system that may be used in connection with various embodiments described herein.

FIG. 9 illustrates an exemplary vehicle rooftop cooling system providing for delivery of coolant to and from various vehicle components that require active cooling.

### DETAILED DESCRIPTION OF PREFERRED EMBODIMENTS

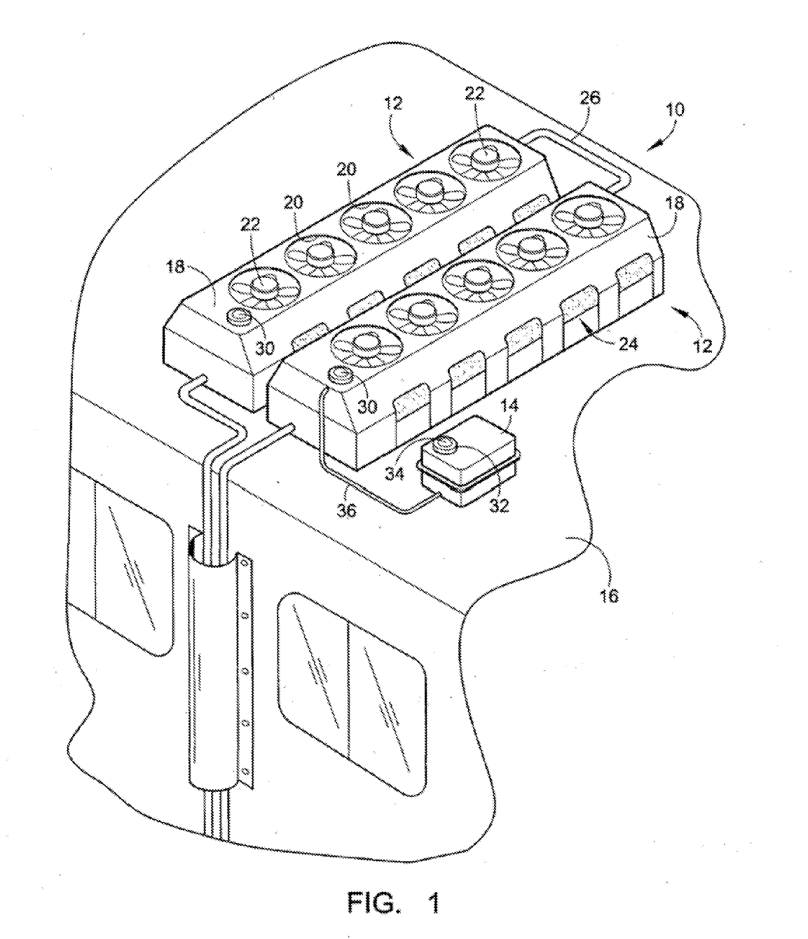

With reference to FIG. 1, an embodiment of a horizontal rooftop engine cooling system 10 will be described. The horizontal rooftop engine cooling system 10 is preferably implemented on a rooftop 11 of a bus; however, it should be fully understood that the rooftop engine cooling system 10 may be applied to the rooftop of any vehicle propelled by a propulsion system requiring cooling. Further, the rooftop engine cooling system 10 may be incorporated into new vehicles or may be a retrofitted onto existing vehicles.

The rooftop engine cooling system 10 may include one or more horizontal radiator units 12 and an optional overflow tank 14 located on the rooftop 11 of a vehicle 16. Each horizontal radiator unit 12 may include one or more types of shrouds 18 having one or more fan orifices 20 and one or more respective electrically driven, thermostatically controlled fans 22 housed over a radiator 24.

The type of shroud 18 can be for fan mounting, aerodynamic air-flow, or ornamental. A fan mounting shroud provides structure for the mounting placement and proper spacing of the one or more fans 22 from the radiator 24 and has one or more fan orifices 20 to obtain a more uniform air flow for removing heat from the radiator 24. A fan mounting shroud is typically used with all automotive radiator installations. An aerodynamic shroud has a surface design that ducts and directs the air flow across a moving vehicle to provide or assist the cooling air flow through the radiator 24. An ornamental shroud is used to cover the cooling system installation for aesthetic appearance and/or safety protection against inadvertent fan blade contact. The electrically driven, thermostatically controlled fans 22 may be electrically connected to one or more power sources of the vehicle 16 through wiring. Any of the shrouds 18 may be attached to a horizontal mounting frame 25, which is mounted to the rooftop 11 of the vehicle 16.

The configuration of the horizontal radiator units 12, and the number of fan orifices 20 and fans 22 may vary depending upon such factors as the configuration of the rooftop 11 of the vehicle 16, the size of the fans 22, and the cooling requirements of the vehicle engine. Although the one or more elongated radiator units 12 of the cooling system 10 are shown mounted perpendicular to the direction of vehicle travel, in an alternative preferred embodiment, the one or more elongated radiator units 12 of the cooling system 10 are mounted parallel to the direction of vehicle travel.

The radiators 24 may be interconnected by tubing 26. The tubing may interconnected to provide either complete flow or partial flow with bypass through each radiator. A partial flow with bypass is typically used in the art as a method for eliminating trapped air from within the liquid coolant tanks and passages. Each radiator 24 may have a conventional fill orifice 28 and pressure cap 30. The optional overflow tank 14 may have a conventional fill orifice 32 and cap 34. The overflow tank 14 may be connected to the fill orifice 28 of one of the radiators 24 through tank connecting tube 36.

Interconnecting tubing 35 covered by a secondary heat shield 37 may run down along a side 39 of the vehicle 16 for connecting the rooftop engine cooling system 10 to the one or more coolant passages of the vehicle engine in the engine compartment. In alternative embodiments, the interconnecting tubing 35 may run inside the vehicle 16, outside the vehicle 16, or a combination of inside and outside the vehicle 16. In the embodiment of the rooftop engine cooling system 10 where the system 10 is incorporated into a new vehicle, the interconnecting tubing 35 may also be incorporated into the vehicle design. One or more circulation pumps (not shown) may be used to pump coolant through the rooftop engine cooling system 10, the vehicle engine, and the interconnecting tubing.

In an alternative embodiment, an electric heater unit may be added to the system 10 to heat the coolant to a convenient working temperature under extreme cold weather conditions.

The one or more of the rooftop radiator units 12 may work in combination to cool the vehicle engine or the one or more radiator units 12 may be separate rooftop radiator units 12 that are separately used to cool separate vehicle components requiring cooling. For example, but not by way of limitation, a first rooftop radiator unit 12 may be used for cooling the vehicle engine, and a separate, second rooftop radiator unit 12 may be used to cool another vehicle component requiring cooling (e.g., a turbo charger intercooler, a high power electric motor drive, or an inverter-controller of a hybrid bus).

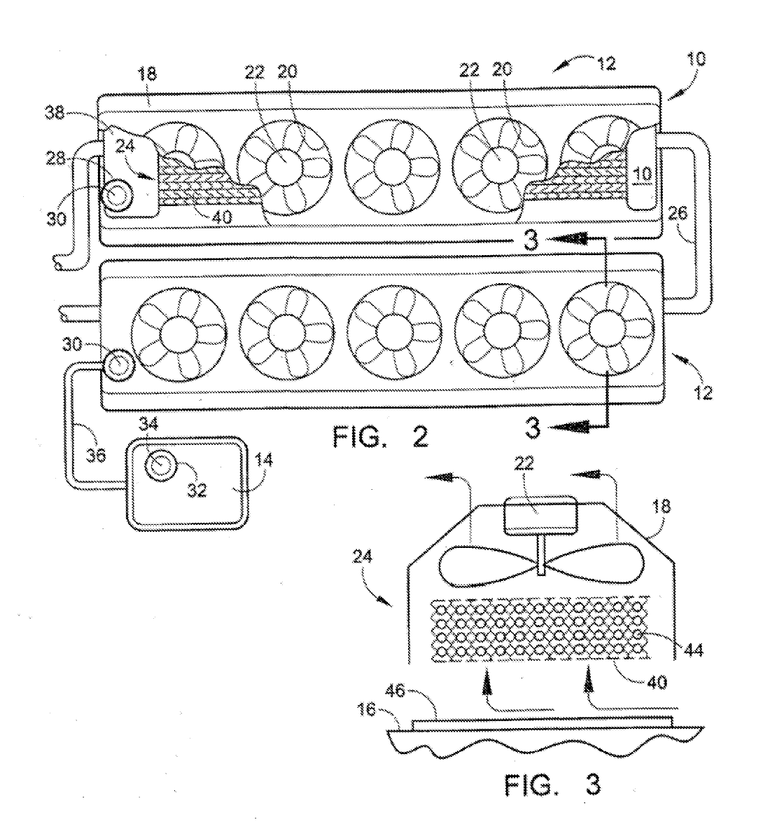

FIG. 2 is a top plan view of the rooftop engine cooling system 10. The two radiator units 12 are shown connected by the interconnecting tubing 26 and connected to the optional overflow tank 14 through tank connecting tube 36. Portions of the fan mounting shroud 18 are shown broken away to reveal the radiator 24. The radiator 24 may include a radiator intake tank 38, a radiator core 40 and a radiator exit tank 42. One or more fluid level floats (not shown) in one or more of the tanks may be used to indicate the coolant fluid level to the vehicle instrumentation system, including but not limited to, a gage located on a dashboard of the vehicle 16. Also shown are the plurality of fan orifices 20 and thermostatically controlled electric fans 22.

FIG. 3 shows that the radiator core 40 of the radiator 24 may include a plurality of fine radiator core tubes 44. A heat shield 46 may be located between the rooftop engine cooling system 10 and the rooftop 11 of the vehicle 16.

In FIG. 3, ambient air may flow into the side of the radiator unit 12 through air inlet(s) 48, underneath the radiator core 40, over the radiator core 40, and up and out of the fan orifice(s) 20 with the assistance of the fan 22.

The large surface area of the roof top 11 significantly reduces the fan power requirement by more than a factor of ten compared to a standard radiator in an engine compartment. The larger surface area of the roof top 11 causes the airspeed through the much larger horizontally mounted radiator units 12 to be reduced and the air pressure drop across the radiator units 12 to be reduced, increasing the cooling system efficiency. For example, standard bus radiators/intercoolers consume up to 50 HP of engine power to drive the radiator cooling fan alone. The electrically driven radiator fans 22 consume less than 3 HP for equivalent cooling. This results in decreasing the engine load by more than 20% (50 HP−3 HP=47 HP; assuming 185-280 HP at full power for a standard 40 ft. bus engine). In one preferred embodiment mounted on a model RTS NOVA bus, the standard fan consumed 40 to 50 HP while the horizontal rooftop cooling system required 1.5 HP at full fan power. This approximately 30 times power reduction demonstrates the significant benefits of the horizontal rooftop cooling system.

The horizontal rooftop engine cooling system 10 also allows for natural convectional air current to rise through the radiator units 12 and allows ambient air to easily flow into and through the cooling system 10, minimizing the power burden of the fans 22. Natural convection currents of the heated cooling fluid may also assist the circulation pump(s) in conveying the coolant through the rooftop engine cooling system 10. With the radiator units 12 unconfined on the rooftop 11 of the vehicle 16, and with less demanding size limitations, the heat may be dissipated in a natural upward direction, minimizing the use of the electrically driven, thermostatically controlled fans 22. Consequently, the load of the electrically driven, thermostatically controlled fans 22 is far less than that of fans of a standard radiator located in the engine compartment of a vehicle. This greatly improves the efficiency of the vehicle 16.

In addition to reducing the load on the engine and/or power sources of the vehicle 16, moving the cooling system 10 from the engine compartment to the rooftop 11 of the vehicle improves the airflow of ambient air into the engine compartment and over the engine, and makes the engine compartment more accessible, reducing maintenance and repair time.

A further benefit of locating the cooling system 10 on the rooftop 11 of the vehicle 16 is that some of the cleanest and coolest air is available at the altitude of the rooftop 11, reducing the number of times the radiator needs to be serviced and increasing the duration between radiator cleanings. Because radiator cleaning requirements stipulate that the radiator be cleaned in the opposite direction of the airflow, the cooling system 10 can be cleaned by simply spraying water through the fan orifices 20 and fans 22 of the ornamental shroud 18 from outside of the cooling system 10 such as may occur during a normal bus wash cycle. This is much simpler and less time-consuming than cleaning a radiator from the inside of the engine compartment, which may require partial disassembly of the radiator shroud to effectively clean the radiator.

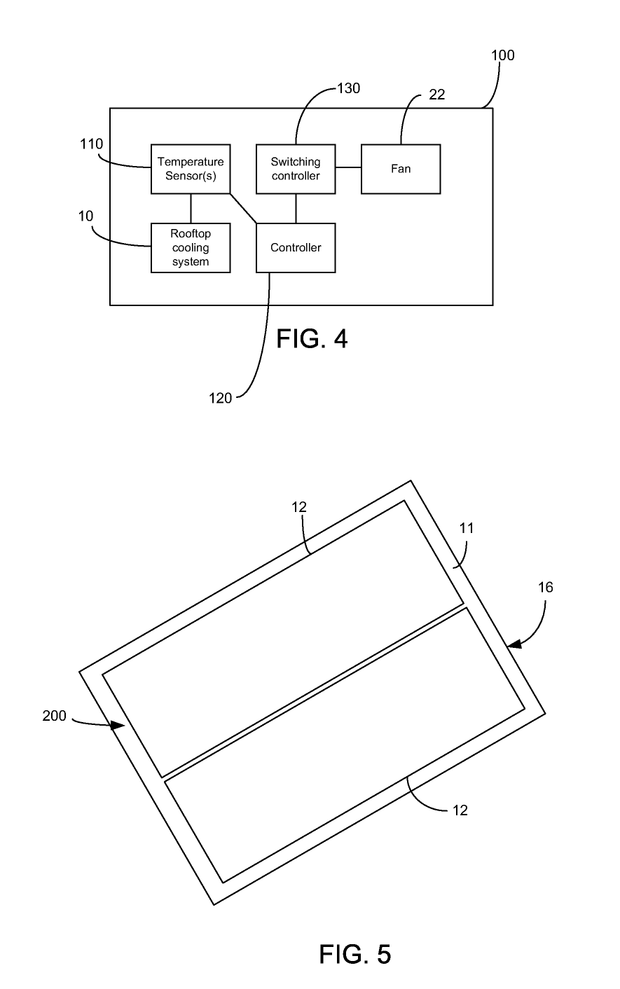

With reference to FIG. 4, an embodiment of a continuously variable power drive and speed control system (“control system”) 100 for rooftop fan(s) 22 will be described. The control system 100 includes one or more temperature sensors 110 thermally coupled to the rooftop engine cooling system 10 to determine coolant temperature. A controller 120, which in the embodiment shown is a digital microcomputer, includes an algorithm to determine the minimum desired air movement and fan speed. A switching controller 130 is controlled by the controller 120 to vary the voltage, and, hence, vary the speed, of the fans 22.

The controller 120 receives coolant temperature information from the temperature sensor(s) 110 and uses an algorithm in a digital microcomputer to determine the minimum desired air movement and fan speed. Keeping fan speed at a minimum conserves vehicle accessory power and minimizes fan audible noise for the environment. The control algorithm uses the coolant temperature to determine the desired voltage square-shaped waveform (e.g., PWM power waveform) for the desired average DC voltage and fan speed. The fan speed is controlled by varying the voltage with the switching controller 130. The controller 130 uses power transistors called IGBT's to turn on and off the supply voltage in pulse width modulation to vary the average voltage applied to the fan(s) 22. In the embodiment shown, waveforms are used to change the average fan voltage in 10% steps; however, in an alternative embodiment, the pulse widths can be varied to produce continuously variable power drive and speed control for the rooftop fans 22. The switched controller 130 is significantly more efficient and variable than a tapped resistor controller.

With reference to FIG. 5, another embodiment of a rooftop engine cooling system 200 will be described. The rooftop engine cooling system 200 includes two radiator units 12 longitudinally oriented/aligned with the longitudinal direction of the rooftop 11 of the vehicle 16 (e.g., bus). Although two radiator units 12 are shown, the rooftop engine cooling system 200 may include one or more radiator units 12. Further, although the rooftop engine cooling system 200 is shown longitudinally oriented with the longitudinal direction of the rooftop 11, the rooftop engine cooling system 200 may be laterally oriented (or oriented in another direction) with respect to the rooftop 11.

In a preferred embodiment of the rooftop engine cooling system 200, the area footprint of the rooftop engine cooling system 200 occupies at least 70% of the area of the rooftop 11 of the vehicle 16. In a more preferred embodiment, the area footprint of the rooftop engine cooling system 200 occupies at least 80% of the area of the rooftop 11 of the vehicle 16. In a most preferred embodiment, the area footprint of the rooftop engine cooling system 200 occupies at least 90% of the area of the rooftop 11 of the vehicle 16. Providing a rooftop engine cooling system 200, especially a longitudinally oriented rooftop engine cooling system 200, on the rooftop 11 to match the shape of the bus rooftop 11 with a larger radiator surface area minimizes the cooling air flow and corresponding fan power required to cool the rooftop engine cooling system 200.

The longitudinal orientation for the rooftop engine cooling system 200 was chosen to match the shape of the bus rooftop 11. The rooftop location on a bus offers more square area space than other bus locations to place a liquid/air heat exchanger. Greater exposed surface area for the liquid coolant/air interface of the rooftop engine cooling system 200 translates to less required air flow across the interface surface area to achieve a given level of cooling. The limited space available in a bus engine compartment requires high air flow volumes to achieve the required cooling. To get higher air flows through the typical engine compartment radiator requires an exponentially increasing level of power to drive the fan. Also, high-flow fans in the engine compartment create high audible noise for the surrounding environment. By using a larger area rooftop engine cooling system 200 on the bus rooftop 11 the required air flow and, therefore, the power to drive the fans is significantly minimized and results in a savings of 30 to 50 horsepower (and adds to the vehicle fuel economy) for a typical bus application. Fan noise is also significantly reduced because of lower air velocity with multiple fans. Another advantage is lower maintenance with less debris in that location, compared to ground level, to clog the radiator air flow. And, with variable speed control, as described above with respect to FIG. 4, fan power is only used when required, and audible fan noise is similarly reduced.

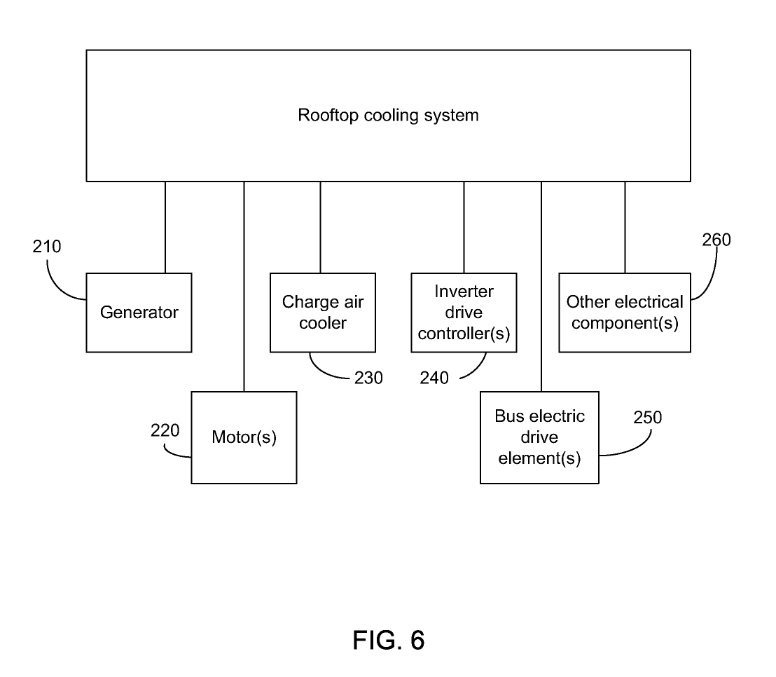

With reference to FIG. 6, a rooftop cooling system similar to those described above may be used for heat exchanger cooling of, but not by way of limitation, one or more of the following components (in addition to or instead of the engine): a generator 210, motor(s) 220, a charge air cooler 230, inverter drive controller(s) 240, bus electric drive element(s) 250, and other electrical component(s) 260. In the example of the charge air cooler, the charge air cooler 230 receives circulated coolant from the rooftop cooling system for cooling turbo charger air to the engine (diesel or gasoline) intake manifold.

In a preferred embodiment, the above described rooftop cooling system is installed in a hybrid-drive vehicle, especially a metropolitan transit bus. One major advantage of a hybrid-drive vehicle is that large amounts of power are available in electric form, rather than only mechanical form. This advantage allows for vehicle components/systems having high power requirements, such the cooling system, to no longer be required to be physically located within a mechanical coupling distance of the engine. Rather, as discussed above, systems may be relocated to non-traditional locations that are more optimally suited to the vehicle's requirements and features. Moreover, a well-known problem of hybrid-electric systems is heat, and the need to dissipate it from the electrical components. As discussed above, a rooftop cooling system for a vehicle offers superior performance, requires less energy to operate, and is well-suited to be powered by electricity, which is readily available in the hybrid system.

Also, another major advantage of a hybrid drive vehicle is the recapture of kinetic energy, or braking regeneration. During braking regeneration, the momentum of the vehicle drives the wheel motors to generate electricity, which then is then returned to the drive system for use, storage, and/or dissipation. The braking regeneration process not only produces heat by itself, but to improve the braking performance, excess energy that cannot be used or stored is bled off through braking resistors in the form of heat. Thus, this process produces additional cooling requirements for the vehicle. Again this rooftop cooling system is ideal because it not only dissipates heat more efficiently, but it can also reuse the excess energy to operate itself.

Although providing a rooftop cooling system for a vehicle may offer superior performance, it may also create new communication and control challenges, as well as maintenance and diagnostic challenges. For example, referring to FIG. 1 and FIG. 4, since the engine and the radiator are no longer in close proximity, the distance between the rooftop radiator 24 and the engine creates a response lag, and using standard cooling techniques to command cooling and fan speed may result in unstable temperature control.

Typically, a vehicle cooling system will use a temperature sensor located in the engine to determine a cooling need (i.e., when the coolant in the engine gets hot, the fan clutch engages the fan for cooling). As discussed above, the instability may occur, for instance, due to the time that it takes for the cooled coolant to travel from the rooftop 11 back to the temperature sensor in the engine. Also, due to the distance between the engine and the rooftop radiator, the control signal wiring may be more susceptible to damage and failure. Moreover, as discussed above, in a hybrid-system, the cooling system may not only be used to cool the engine, it may also be used to cool other drive system components, which may require cooling at different times than the engine. In one implementation, where one or more energy storage devices (e.g., batteries, ultracapacitors, etc.) are disposed on the rooftop 11, the vehicle rooftop cooling system may also be used (or be alternatively used) to provide rooftop energy storage cooling.

The current “one-size-fits-all” method for engaging the cooling system is not efficient and provides inferior performance. This is particularly true for hybrid systems during braking regeneration. For example, when braking to a stop or coasting down hill, the engine typically may have a low cooling requirement whereas the braking resistors and other related electrical components may have a very high cooling requirement. If the cooling system is operated based on the coolant temperature at the engine, there may be substantial delay before the cooling system is triggered. This may lead to premature failure and, at a minimum, an underperforming cooling system.

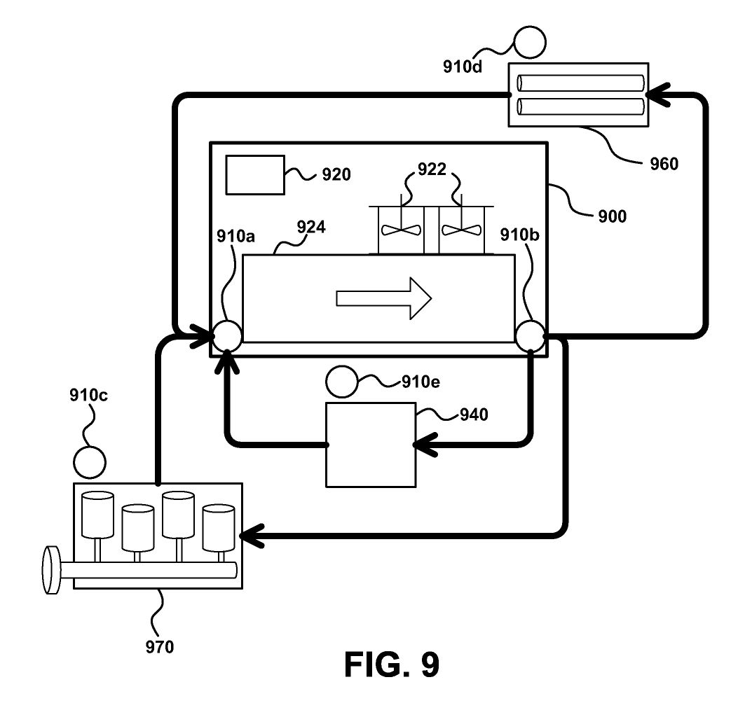

To address these challenges and others, FIG. 9 illustrates an exemplary vehicle rooftop cooling system providing for delivery of coolant to and from various vehicle components that require active cooling. The cooling system 900 should include, in addition to the rooftop radiator 924 and fans 922 (or other means for heat extraction), a first sensor 910a proximate to the rooftop radiator 924 and configured to measure the temperature of the coolant at the radiator 924. According to one embodiment, the first sensor 910a will be located proximate the intake of the radiator 924. In this way the fans 922 may engage immediately when there is a need.

By taking temperatures right at the site of cooling (on the rooftop 11), the return coolant temperature and/or heat rejection can be controlled, rather than attempting to satisfy a temperature sensor 910c located away at the engine 970 that may take several seconds to see the temperature change. In other words, utilizing temperature sensors 910a, 910b built into the system 900 provides for the fan(s) 922 to be controlled more accurately and with a shorter response time, based on actual radiator 924 conditions.

Although illustrated near radiator 924 intake, sensor(s) 910a may be integrated anywhere in cooling system 900 or nearby. For example, in a preferred embodiment, cooling system 900 may include inlet sensor(s) 910a at or near radiator 924 inlet and outlet sensor(s) 910b at or near radiator 924 outlet. Controller 920 may then receive inputs from sensors 910a, 910b. In this way, differential measurements can be compared to determine the performance/efficiency of the cooling system as a whole.

Also, sensor(s) 910a location may vary depending on which components may be controlled by the controller 920. For example, in a preferred embodiment, cooling system 900 may send control signals to vary the speed of individual fans 922. Accordingly, sensor(s) 910a may be located throughout the radiator 924, proximate to individual fans 922. In this way, individual measurements can be taken and compared to each other to determine the performance/efficiency of the individual fans. Where one fan is underperforming, this may indicate a faulty fan, a blocked flow path, etc., Moreover, fans or other cooling system components may be recalibrated overtime based on temperature sensor readings.

In a further implementation, the sensor 910a may include multiple sensors. For example, sensor(s) 910a may include any combination of temperature, mass flow, current, coolant level, vibration, blockage, contamination, and pressure sensors, which may measure coolant, air, and/or system conditions. Additionally, sensor(s) 910a may operate on electrical, mechanical, chemical, and/or optical principals. As discussed below, using the information from these and other sensors, determinations can be made as to performance degradation, blockage of water/coolant, air, etc., and either sent a control signal or compensate by altering fan power levels.

According to a preferred embodiment, any components requiring active cooling may also include associated sensors that are local to the component but remote from the radiator. For example, one or more sensor(s) 910c, similar to those described above, may be located in or near the engine 970. Similarly, when the vehicle includes braking resistors 960 one or more sensor(s) 910d, as described above, may be located in the braking resistors 960 or nearby. Preferably, additional component(s) 940 (e.g., generator, electric motor, charge air cooler, inverter drive controller, bus electric drive element, etc.) should also include sensor(s) 910e. Additionally, where components are sufficiently close, a single sensor may provide a single measurement that represents one or more components.

The cooling system 900 should also include a controller 920 that is communicably coupled to the first sensor 910a. The controller 920 should be configured to receive inputs from the first sensor 910a, to make determinations based on received inputs, and to communicate control signals to the cooling system components (e.g., the fan motors, coolant pumps, flow valves, etc.) based on radiator conditions. Preferably, controller 920 should be further configured to receive inputs from the engine sensor(s) 910c, to make determinations based on received inputs, and to communicate control signals to the cooling system components in response and give status back to the vehicle computer or a vehicle diagnostic unit (typically used for remote reporting).

According to alternate embodiments, reduced or increased cooling temperatures may be required for special situations related to certain vehicle components, but unrelated to engine conditions. Accordingly, with respect to braking resistor 960 and additional component(s) 940, sensor(s) 910d and 910e should also be communicably coupled to controller 920. Controller 920 may then be configured to also communicate control signals to the cooling system components based on non-engine components cooling requirements.

According to another alternate embodiment, the controller 920 may be further configured to operate as a forward-feedback control to anticipate a future cooling need based on receiving information generally considered outside of the cooling system. For example, controller 920 may provide forward-feedback control signals that are responsive to receiving inputs related to one or more of: braking resistor activation/deactivation, accelerator activation/deactivation, brake pedal activation/deactivation, vehicle passenger compartment heating/cooling system activation/deactivation, electrical loads applied/removed to/from electrical accessories, vehicle location information (e.g., prior to a stop, or prior to a hill, etc.), road conditions, etc. Although this information is not directly linked to a coolant condition, it can be considered indicative of coming cooling system change. With this information, the controller 920 may then initiate, terminate, or otherwise modify the operation of the cooling system in advance and further reduce transient effects of the cooling system being away from the engine, and transient effects in general.

While cooling system 900 is most effectively utilized with controller 920 configured to receive inputs from the various remote sensors 910c, 910d, 910e, in an alternative embodiment, controller 920 may be configured to operate/control cooling system 900 as a stand-alone cooling system. For example, sensors 910a, 910b may be located at or near the radiator 924 inlet and outlet so that the unit can operate independently to either maintain a fixed inlet temperature and/or a fixed outlet temperature.

According to a preferred embodiment though, controller 920 is configured to receive inputs from the various remote sensors 910c, 910d, 910e, and controller 920 is further configured to communicate across a Controller Area Network (CAN). CAN is a broadcast, differential serial bus standard, originally developed in the 1980s by Robert Bosch GmbH, for automotive purposes (as a vehicle communication bus) for connecting electronic control units (ECUs). CAN was specifically designed to be robust in electromagnetically noisy environments such as vehicles and can utilize a differential balanced line like RS-485. It can be even more robust against noise if twisted pair wire is used. In hybrid-drive applications, it can be particularly useful for the controller to “speak CAN”, as this will enable the controller communicate with multiple vehicle components.

Hybrid systems often use CAN-compliant ECUs to communicate and control the various onboard equipment. As such, many hybrid vehicles already have a CAN communication network in place. Thus, a CAN compliant cooling system controller may make use of the vehicle communication bus, thus eliminating the need for a dedicated communication link. Also, as discussed above, a hybrid system will often have additional, and diverse cooling demands. Since these demands will not always coincide, the controller 920 may have improved performance if it can communicate over the CAN network directly with a component having a cooling need.

It is also preferable that the cooling system controller 920 be further configured to communicate across a CAN because it allows the cooling system 900 to communicate with onboard vehicle diagnostic equipment. This is especially true where multiple sensors on multiple components are utilized, since CAN communications are robust and provide for multiple devices to use a single communication bus. The cooling system information can then be communicated, saved, reported remotely via a diagnostic unit, and/or used by other, more sophisticated, onboard vehicle controllers. Thus, CAN communication increases diagnostic, controls, and programming flexibility while reducing the number of discrete electrical interface points on the vehicle. This also improves maintenance by reducing the amount of time to install, connect, and troubleshoot the rooftop cooling system 10.

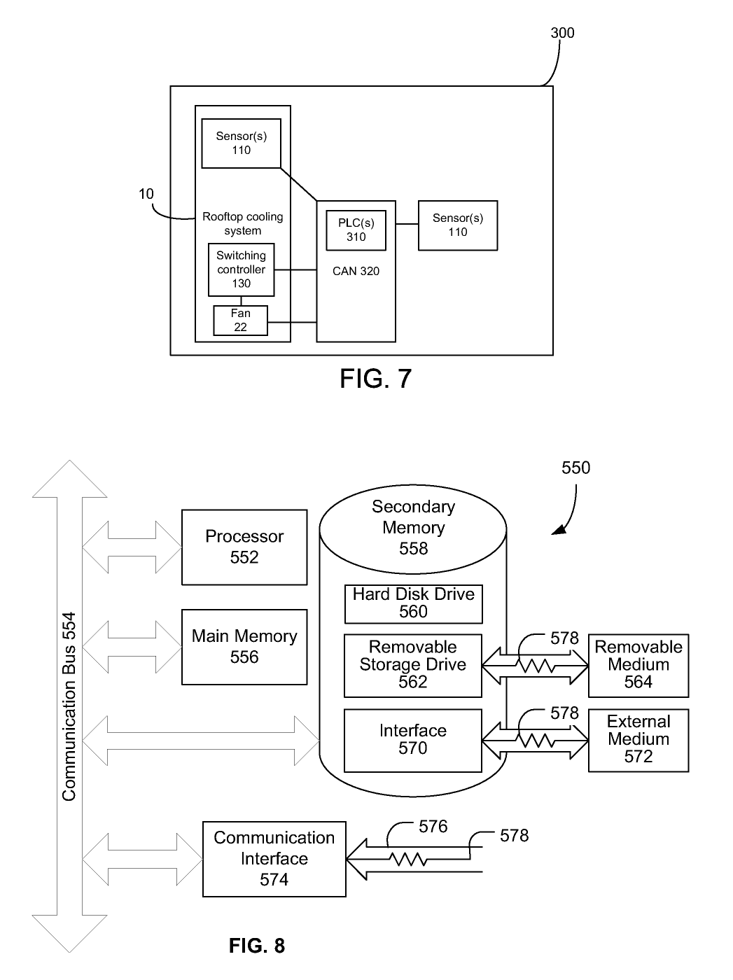

With reference to FIG. 7, another embodiment of a control system 300 includes one or more Programmable Logic Controllers (PLCs) 310. A PLC is a digital computer used for automation of industrial processes, such as control of automotive components. Unlike general-purpose computers, the PLC is designed for multiple inputs and output arrangements, extended temperature ranges, immunity to electrical noise, and resistance to vibration and impact. Programs to control machine operation are typically stored in battery-backed or non-volatile memory. A PLC is also an example of a real time system since output results must be produced in response to input conditions within a bounded time, otherwise unintended operation will result.

The rooftop cooling system PLC(s) 310 may be networked in with the CAN 320, while separate from the engine and independent from other controllers. According to one embodiment, the control system 300 is programmed to communicate over CAN with the various sensors 110 on each component requiring active cooling. Accordingly, control system 300 can deliver cooling based on each component's need. However, in an alternate implementation, the control system 300 is programmed to independently monitor coolant temperatures at the rooftop cooling system 10, and work completely independent of the unit that it cools.

Using PLC 310 provides for increased system flexibility. For example, the PLC may be configured to identify and communicate blocked or failed fans 22 to maintenance personnel and/or a user over vehicle Control Area Network (CAN) 320. In a further implementation, the PLC(s) 310 command the variable-speed fans 22, and record/report coolant and air temperatures. Also, for example, PLC 310 may be used to sense a blocked or failed fan and then shut it off instead of blowing a fuse.

In a still further implementation, the PLC(s) 310 operate as forward-feedback control, as discussed above. Triggers for this forward-feedback control may include one or more of vehicle commands, vehicle location, road conditions, braking regeneration activation/temperature, drive system activation/temperature, and other vehicle cooling requirements,

Forward-feedback is particularly important in hybrid applications having multiple components needing active cooling. Moreover, in hybrid vehicles, there are various indicators of a future cooling need. For example, the moment a vehicle is about to accelerate it is already known that heat will be generated through increased demand on the engine, the energy storage, the motors, and/or the other drive system electrical components. This can be determined advantageously via the CAN network though interpreting accelerator commands, vehicle location, road conditions, etc. In response, rather than waiting for an actual high temperature measurement, PLC(s) 310 may avoid the delay and engage the cooling system in anticipation. This may be done through any combination of increased fan speed, increased coolant flow, opening/closing coolant paths, etc.

Likewise, the moment a vehicle is about to decelerate it is already known that heat will be generated through the recapture, storage, and dissipation of kinetic energy. Again this event may be determined in advance via the CAN network though interpreting accelerator commands, vehicle location, road conditions, etc. In response, PLC(s) 310 may similarly avoid delay, and engage the cooling system in anticipation of one or more of these cooling needs.

In a further implementation, the sensor 110 includes multiple sensors 110. The multiple sensors 110 include more than one of the following sensors: temperature, mass flow, current, pressure, optical, vibration, and chemical. The multiple sensors are configured to measure one or more of coolant temperature going into radiator, coolant temperature leaving radiator, coolant flow rate, coolant pressure, ambient temperature, fan current draw, fan blockage, cooling air flow rate, objects in the coolant (e.g., via optical sensor viewing glass tube), bubbles in coolant, quality of coolant (e.g., whether there is 50/50 water/coolant mix), vibration of rooftop components, temperature of other vehicle components that require cooling (e.g., hybrid drive, braking resistors, air conditioner, etc.). These measurements may be made at one or multiple locations associated with the component to be measured. In a preferred embodiment, measurements may be taken at the intake and exhaust of the component, thus providing for a differential measurement across the component.

The PLC(s) 310 receive input from the multiple sensors 110 to determine one or more of fan performance/efficiency, or lack thereof, fan faults (i.e., blockage or shut down), coolant pump performance/efficiency, or lack thereof, coolant pump failure, radiator performance/efficiency, or lack thereof, radiator blockage (air or coolant), overall cooling performance/efficiency, and “feed forward” an anticipated cooling need.

Based on the above determinations, the PLC(s) 310 perform one or more of the following via the CAN 320: modify operation of one or more fans, shut off one or more fans, modify operation of coolant pump, shut off coolant pump, modify operation of or de-rate hybrid drive components (engine, motors, inverters, etc.), re-calibrate fans to operate on a revised expected performance curve based on measured conditions, re-calibrate coolant pump to operate on a revised expected performance curve based on measured conditions, trigger cooling system to activate early in anticipation of imminent cooling need, forward information to other vehicle systems, and alert vehicle operator of measured conditions/faults.

FIG. 8 is a block diagram illustrating an example computer system 550 that may be used in connection with the embodiment of the controllers 120, 920, and/or PLC(s) 310 described herein. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The vehicle rooftop engine cooling systems and control systems shown in the drawings and described in detail herein disclose arrangements of elements of particular construction and configuration for illustrating preferred and alternate embodiments of structure and method of operation of the present invention. It is to be understood, however, that elements of different construction and configuration and other arrangements thereof, other than those illustrated and described may be employed for providing a rooftop engine cooling system and control system in accordance with the spirit of this invention, and such changes, alternations and modifications as would occur to those skilled in the art are considered to be within the scope of this invention as broadly defined in the appended claims.

What is claimed is:

1. A vehicle rooftop cooling system, comprising:
a radiator located on the rooftop of the vehicle, the radiator having a liquid coolant inside the radiator;
a fan coupled to the radiator and configured to extract hot air from the radiator;
a first sensor in or proximate to the radiator configured to measure coolant temperature of the coolant in or proximate to the radiator;
a controller communicably coupled to the first sensor, the controller configured to receive inputs from the first sensor, to make determinations based on received inputs, issue control signals in response to said determinations, and to communicate across a Controller Area Network (CAN).

2. The vehicle rooftop cooling system of claim 1, wherein the fan is a variable-speed fan.

3. The vehicle rooftop cooling system of claim 1, wherein the first sensor includes multiple sensors configured to measure one or more of coolant temperature going into radiator, coolant temperature leaving radiator, coolant flow rate, coolant pressure, ambient temperature, fan current draw, fan blockage, cooling air flow rate, objects in the coolant, bubbles in coolant, quality of coolant, vibration of rooftop components.

4. The vehicle rooftop cooling system of claim 1, further comprising a second sensor located remotely from the radiator;
wherein the controller is communicably coupled to the second sensor via the Controller Area Network (CAN), and the controller is further configured to receive inputs from the second sensor.

5. The vehicle rooftop cooling system of claim 4, wherein the second sensor includes multiple sensors, the multiple sensors including at least one of the following sensors: temperature sensor, mass flow sensor, current sensor, pressure sensor, optical sensor, vibration sensor, and chemical sensor.

6. The vehicle rooftop cooling system of claim 4, further comprising a third sensor configured to measure at least one condition of a braking resistor of the vehicle;
wherein the controller is communicably coupled to the third sensor via the Controller Area Network (CAN), and the controller is further configured to receive inputs from the third sensor;
wherein the second sensor is configured to measure at least one condition of an engine of the vehicle.

7. The vehicle rooftop cooling system of claim 1, wherein the controller is further configured to communicate cooling system information over the Controller Area Network (CAN) to at least one of a vehicle computer and a vehicle diagnostic unit.

8. The vehicle rooftop cooling system of claim 1, wherein communicating across a Controller Area Network (CAN) includes receiving inputs via the Controller Area Network (CAN); and
wherein the controller is further configured to operate as a forward-feedback control to anticipate a future cooling need.

9. The vehicle rooftop cooling system of claim 8, wherein forward-feedback control signals are responsive to one or more of: braking resistor activation/deactivation, accelerator activation/deactivation, brake pedal activation/deactivation, vehicle passenger compartment heating/cooling system activation/deactivation, electrical loads applied/removed to/from electrical accessories, vehicle location information, and road conditions.

10. The vehicle rooftop cooling system of claim 1, wherein the controller comprises a Programmable Logic Controller (PLC).

11. The vehicle rooftop cooling system of claim 10, wherein the first sensor includes multiple sensors, and the Programmable Logic Controller (PLC) receives inputs from the multiple sensors to determine one or more of: fan performance, or lack thereof, fan faults, coolant pump performance, or lack thereof, coolant pump failure, radiator performance, or lack thereof, radiator blockage, and overall cooling performance.

12. The vehicle rooftop cooling system of claim 10, wherein the Programmable Logic Controller (PLC) is configured to perform one or more of the following: modify operation of one or more fans, shut off one or more fans, modify operation of a coolant pump, shut off the coolant pump, modify operation of or de-rate at least one hybrid drive component, re-calibrate one or more fans to operate on a revised expected performance curve based on measured conditions, re-calibrate the coolant pump to operate on a revised expected performance curve based on measured conditions, trigger the cooling system to activate early in anticipation of an imminent cooling need, communicate information to other vehicle systems, and alert a vehicle operator of measured conditions.

13. A method of controlling a vehicle rooftop cooling system including: a radiator for liquid coolant, a fan coupled to the radiator to extract hot air, a first sensor in or proximate to the radiator configured to measure temperature, a controller communicably coupled to the first sensor and configured to receive inputs from the first sensor, to make determinations based on received inputs, and to communicate across a Controller Area Network (CAN), the method comprising:
receiving inputs from the first sensor,
making determinations based on received inputs,
issuing control signals in response to said determinations, and
communicating across a Controller Area Network (CAN).

14. The method of claim 13, wherein the first sensor includes multiple sensors, the method further comprising at least one of: measuring coolant temperature going into radiator, measuring coolant temperature leaving radiator, measuring coolant flow rate through the radiator, measuring coolant pressure in or near the radiator, measuring ambient temperature near the radiator, measuring fan current draw, measuring fan blockage, measuring cooling air flow rate across the radiator, measuring objects in the coolant, measuring bubbles in coolant, measuring quality of coolant, and measuring vibration of rooftop components.

15. The method of claim 14, wherein the vehicle rooftop cooling system further includes a second sensor located remotely from the radiator, and wherein the controller is communicably coupled to the second sensor and configured to receive inputs from the second sensor, the method further comprising receiving inputs from the second sensor via the Controller Area Network (CAN).

16. The method of claim 15, wherein the second sensor includes multiple sensors, the method further comprising at least one of: measuring coolant temperature; measuring coolant mass flow; measuring electrical current; measuring coolant pressure; measuring optical qualities of the coolant; measuring vibration; and, measuring chemical qualities of the coolant.

17. The method of claim 15, wherein the vehicle rooftop cooling system further includes a third sensor configured to measure at least one condition of a braking resistor of the vehicle, wherein the controller is communicably coupled to the third sensor and configured to receive inputs from the third sensor, and wherein the second sensor is configured to measure at least one condition of an engine of the vehicle, the method further comprising receiving inputs from the third sensor via the Controller Area Network (CAN).

18. The method of claim 13, wherein the communicating across a Controller Area Network (CAN) comprises communicating cooling system information over the Controller Area Network (CAN) to at least one of: a vehicle computer and a vehicle diagnostic unit.

19. The method of claim 13, wherein the communicating across a Controller Area Network (CAN) includes receiving inputs via the Controller Area Network (CAN), the method further comprising operating the controller as a forward-feedback control to anticipate a future cooling need.

20. The vehicle rooftop cooling system of claim 19, wherein forward-feedback control signals are responsive to receiving inputs related to one or more of: braking resistor activation/deactivation, accelerator activation/deactivation, brake pedal activation/deactivation, vehicle passenger compartment heating/cooling system activation/deactivation, electrical loads applied/removed to/from electrical accessories, vehicle location information, and road conditions.

21. The method of claim 13, wherein the controller comprises a Programmable Logic Controller (PLC), the method further comprising programming the Programmable Logic Controller (PLC) to control the vehicle rooftop cooling system.

22. The method of claim 21, wherein the first sensor includes multiple sensors, the method further comprising:
receiving inputs from the multiple sensors; and
determining one or more of: fan performance, or lack thereof, fan faults, coolant pump performance, or lack thereof, coolant pump failure, radiator performance, or lack thereof, radiator blockage, and overall cooling performance.

23. The method of claim 21 further comprising one or more of the following:
modifying operation of one or more fans;
shutting off one or more fans;
modifying operation of a coolant pump;
shutting off the coolant pump;
modifying operation of or de-rate at least one hybrid drive component;
re-calibrating one or more fans to operate on a revised expected performance curve based on measured conditions;
re-calibrating the coolant pump to operate on the revised expected performance curve based on measured conditions;
triggering the cooling system to activate early in anticipation of an imminent cooling need;
communicating information to other vehicle systems, and
alerting a vehicle operator of measured conditions.
